(19) United States
(12) Patent Application Publication
(10) Pub. No.: US 2016/0157626 A1
(43) Pub. Date: Jun. 9, 2016

(54) METHOD FOR PRODUCING A POCKET SPRING CORE

(71) Applicant: AGRO HOLDING GMBH, Bad Essen (DE)

(72) Inventor: WOLFGANG GROTHAUS, Bad Essen (DE)

(73) Assignee: AGRO HOLDING GMBH, 49152 Bad Essen (DE)

(21) Appl. No.: 14/903,524

(22) PCT Filed: Jul. 8, 2014
(86) PCT No.: PCT/EP2014/064648

§ 371 Date: Jan. 7, 2016

(30) Foreign Application Priority Data
Jul. 9, 2013 (DE) 10 2013 107 255.0

(51) Int. Cl. A47C 27/06; B68G 9/00

(52) U.S. Cl. CPC A47C 27/064; B68G 9/00

(57) ABSTRACT

A method for producing a pocket spring core including multiple interconnected spring coils, each having a plurality of individual helical springs arranged one behind the other and encased in a pocket is disclosed. At least some of the spring coils are made of at least two partial spring coils abutting each other at their end faces. A spring coil made of partial spring coils is formed by progressively synchronously joining and interconnecting the partial coils together in the position in which their end faces point towards each other relative to the longitudinal axes of their individual springs.

The invention relates to a method for producing a pocket spring core according to the preamble of claim 1.

Such a method is known from WO 2004/078001 A1, in which spring coils which are situated adjacent to each other and differ with respect to their height are connected to each other. This leads to partial gaps in the surface of the spring core which are filled by filling material, wherein said filling material can consist of spring coils joined into a partial spring core, whose springs are dimensioned with respect to their height in such a way that the gap is filled and a substantially flat reclining surface is obtained.

For this purpose, the individual pocket spring cores, i.e. the one with the springs that differ with respect to their height and the one filling the gap, are produced separately, for which purpose the previously formed spring coils are joined to each other by gluing for example.

The partial spring core is only placed into the formed gap and the thus completed pocket spring core is subsequently surrounded by a fabric.

This type of production leads to a number of disadvantages however. The production is extremely work-intensive because—as mentioned above—separate production of the partial spring cores is necessary, which subsequently need to be joined again manually.

Automation of this process has been impossible so far, especially in cases where pocket spring cores are produced which differ from each other with respect to partial spring characteristics, i.e. in which the partial spring cores that fill the formed gaps differ from each other both with respect to their surface dimension and also with respect to their height.

In addition to the high production costs, which are the result of manual production, it can only be carried out under adverse working conditions. This is especially due to the fact that the partial spring cores are relatively heavy and can only be handled with difficulty due to their limpness.

The problems arising as a result of these physical strains are obvious and need not be explained in detail.

All told, the known production method is not capable of meeting the demands for optimisation concerning the physical strain of the production staff and the production costs in general. This is especially relevant under the aspect that pocket spring cores are produced in large numbers.

The invention is based on the object of further developing a method of the generic type in such a way that it can be carried out with low effort in a simpler and more cost-effective manner.

This object is achieved by a method with the features of claim 1.

As a result of such a method, in which in contrast to the prior art each spring coil is completed by face-end connection of different, previously produced partial spring coils to each other, automated production of the pocket spring core can be provided, wherein the individual springs of each partial spring coil can differ from the individual springs of the other partial spring coil, both with respect to their height and also with respect to the other constructional features which influence the spring characteristics such as wire thickness or the like.

If necessary, any desired number of spring coils can be stacked on top of each other, wherein all formed spring coils have the same height, so that a pocket spring core is obtained with continuously flat and parallel broad sides, i.e. reclining surfaces.

According to a further concept of the invention, the partial spring coils are glued to each other on their mutually facing face ends, for which purpose an adhesive is applied to at least one partial spring coil prior to the synchronous joining. After the synchronous joining, the thus formed spring coil is pressurised on both sides, so that solid gluing of the partial spring coils to each other is produced.

It can also be considered to connect the partial spring coils to each other by means of a suitable apparatus after synchronisation by welding.

As already mentioned above, the provided, completed spring coils are processed by means of known machines into spring cores, wherein the spring coils can also be used for this purpose which are not comprised of partial spring coils, but whose individual springs correspond to the height which corresponds to the height of the spring coils which are comprised of the interconnected, stacked partial spring coils.

This offers the possibility of great variety, which allows the production of pocket spring cores with various partial spring characteristics.

An apparatus for carrying out the method comprises two feed devices for partial spring coils which are equipped with pocketed individual springs and which open into a synchronisation apparatus. The partial spring coils are positioned in axial alignment on the face end with respect to their individual springs.

A connecting station is provided downstream of the synchronisation apparatus, in which the partial spring coils are joined at their face ends and are connected in a materially bonded manner. Synchronisation and connection of the partial spring coils occurs progressively in a continuous work sequence.

A gluing apparatus can be provided upstream of the synchronisation device, with which a face end region of at least one partial spring coil is supplied with an adhesive in the manner of a point or a bead, which reaches the other partial spring coil by pressing in the connecting station and is cured after passing through the connecting station.

The pressing force to be applied can be produced in such a way that opposite pressing jaws of the connecting station are situated closer to each other than the total height of the spring coil formed by the partial spring coils in the relaxed position of the individual springs.

The synchronisation device preferably comprises a drive wheel with external toothing, the tooth spaces of which are adapted to the pocketed individual springs with respect to their dimensions and shape, wherein one pocketed individual spring of each partial spring coil rests in a tooth space, thus achieving a positionally precise, i.e. synchronous, position of the two spring coils with respect to each other.

Further advantageous embodiments of the invention are provided in the dependent claims.

The method in accordance with the invention, an apparatus for carrying out the method, and a pocket spring core produced according to the method will be described below in closer detail by reference to the enclosed drawings, wherein:

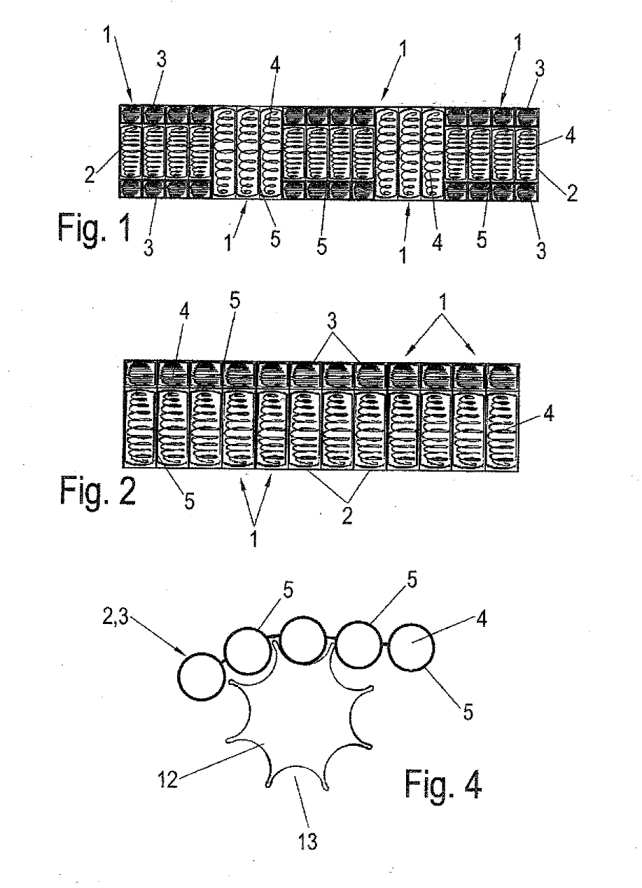

FIGS. 1 and 2 respectively show a schematic front view of different pocket spring cores produced according to the method in accordance with the invention;

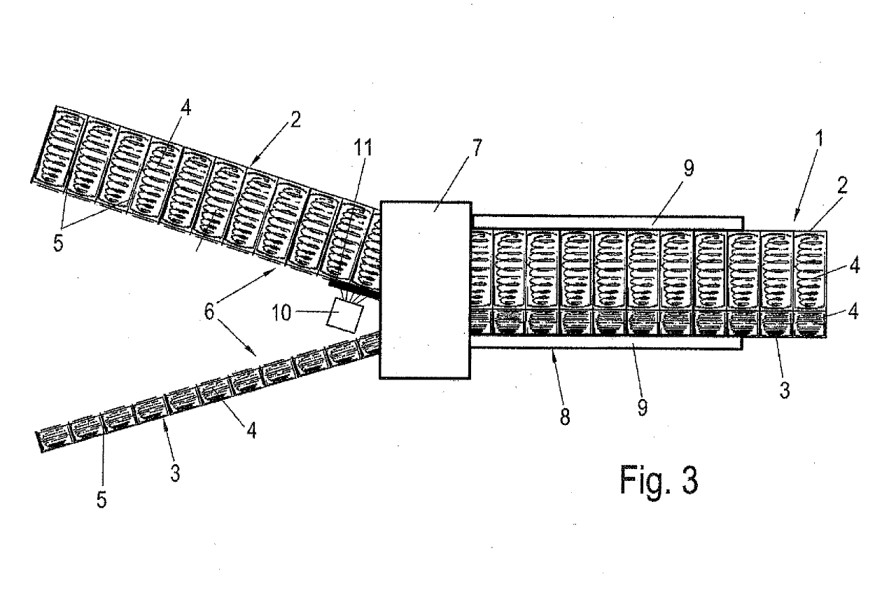

FIG. 3 shows a top view of an apparatus for carrying out the method, which is also shown schematically;

FIG. 4 also shows a schematic view of a section of the apparatus according to FIG. 3.

FIGS. 1 and 2 respectively show an embodiment of a pocket spring core in a cross-sectional view, which are comprised of several equally long and equally high spring coils 1, wherein each spring coil 1 comprises a plurality of successively arranged and pocketed individual springs 4 which are wound in a helical manner.

Adjacent spring coils 1 are connected to each other, preferably glued to each other, in the region of the bulges of several individual springs 4 which rest on each other, wherein the individual springs 4 rest in pockets 5 made of a flexible, especially textile material.

In the embodiment shown in FIG. 1, a part of the spring coils 1 is made of individual springs 4 which extend over the entire height of the spring core.

A further part of the spring cores 1 is formed by partial spring coils 2, 3 which rest on each other at the face end, wherein in the example according to FIG. 1 a middle partial spring coil 2 is covered on both sides, i.e. on the upper and bottom side, via lower partial spring coils 3. The height of the formed spring coil 1 corresponds to the height of the spring coil 1 which does not comprise any partial spring coils 2, 3.

FIG. 2 shows a spring core only with spring coils 1 which are formed by partial spring coils 2, 3, wherein the partial spring coils 3 have a lower height than the partial spring coils 2.

FIG. 3 shows an apparatus for producing a spring coil 1, comprising two feed devices 6, via which the partial spring coils 2, 3 of a synchronisation apparatus 7, which were produced beforehand in the known manner, can be supplied in such a way that the partial spring coils 2, 3 are positioned in axial alignment at the face end with respect to their individual springs 4.

FIG. 4 shows a part of the synchronisation apparatus 7 which includes a drive wheel 12 with external toothing, in the tooth spaces 13 of which the two supplied partial spring coils 2, 3 are positioned, wherein the shape and the cross-sectional dimension of the tooth spaces 13 correspond to the respective shapes and dimensions of the pocketed individual springs 4. An axially aligned orientation of the partial spring cores 2, 3 is thus achieved.

An adhesive application device 10 is provided upstream of the synchronisation apparatus 7, with which an adhesive layer 11 is applied to the face end of the partial spring coil 2 facing the other partial spring coil 3. After passing through the synchronisation apparatus 7, the two spring coils 2, 3 are connected to each other in a connecting station 8, for which purpose opposite pressing jaws 9 are provided whose clearance is respectively smaller than the width of the completed spring coil 1 in the relaxed position.

The produced spring coils are then connected to each other to a spring core in an apparatus (not shown).

1.-13. (canceled)

14. A method for producing a pocket spring core, comprising:
forming a partial spring coil by connecting individual helical springs arranged one behind the other and encased in a pocket;
progressively synchronously joining and interconnecting at least two of said partial spring coils in-end-to-end disposition in relation to a longitudinal axis of their individual springs; and
forming multiple interconnected spring coils, with at least one of the spring coils being made by at least the two of the partial spring coils in-end-to-end disposition.

15. The method of claim 14, further comprising applying an adhesive to a face end of one of the at least two of said partial spring coils prior to progressively synchronously joining and interconnecting the at least two of said partial spring coils.

16. The method of claim 15, further comprising pressing together the at least two of said partial spring coils in a region where the adhesive is applied, after progressively synchronously joining and interconnecting the at least two of said partial spring coils.

17. An apparatus, comprising:
a synchronisation device;
at least two feed devices supplying partial spring coils comprised of individual springs to the synchronisation device, with the synchronisation device being configured to position the partial spring coils, received from the feeding devices, in axial alignment on their face ends with respect to the individual springs; and
a connecting station disposed downstream of the synchronisation device for materially bonded connection of the partial spring coils resting on each other.

18. The apparatus of claim 17, further comprising an adhesive application device arranged upstream of the synchronisation device.

19. The apparatus of claim 17, wherein the connecting station comprises two pressing jaws arranged in parallel spaced-apart relationship, said partial spring coils being guided between the pressing jaws and joined to form a spring coil.

20. The apparatus of claim 19, wherein the pressing jaws define a clearance which is smaller than a height of the formed spring coil in a relaxed position.

21. The apparatus of claim 17, further comprising a transport device configured to move the partial spring coils and/or the formed spring coil progressively.

22. The apparatus of claim 17, wherein the synchronisation device comprises a rotatable drive wheel having external teeth defining tooth spaces in which the pocketed individual springs are positioned for transport.

23. The apparatus of claim 22, wherein the tooth spaces have a shape and dimension in correspondence to a shape and cross-sectional dimension of the pocketed individual springs.

24. A pocket spring core, comprising:
a plurality of interconnected spring coils, each having a plurality of pocketed helical individual springs arranged behind one another, at least a part of the spring coils being formed by at least two partial spring coils which are disposed end-to-end and glued together at their face ends.

25. The pocket spring core of claim 24, wherein the partial spring coils are of equal length.

26. The pocket spring core of claim 24, wherein the spring coils are all of equal length and equal height.
